(19) United States
(12) Patent Application Publication
(10) Pub. No.: US 2025/0279994 A1
(43) Pub. Date: Sep. 4, 2025

(54) MASTER, COUPLER AND SLAVE FOR A COMMUNICATIONS NETWORK

(71) Applicant: Turck Holding GmbH, Halver (DE)

(72) Inventors: Markus Fischer, Zwickau (DE); Jens Köhler, Chemnitz (DE); René Schubert, Chemnitz (DE)

(73) Assignee: Turck Holding GmbH, Halver (DE)

(21) Appl. No.: 19/212,870

(22) Filed: May 20, 2025

Related U.S. Application Data
(63) Continuation of application No. PCT/EP2023/081803, filed on Nov. 14, 2023.

(30) Foreign Application Priority Data
Nov. 24, 2022 (LU) LU503109

(51) Int. Cl. H04L 9/40

(52) U.S. Cl. CPC H04L 63/083

(57) ABSTRACT

The disclosure relates to a master for connecting to a communications network, wherein the master is designed such that, according to a predetermined communications standard, it outputs process data cyclically and device data acyclically to the communications network, and such that it outputs, by means of the device data, a predetermined control command including a predetermined password to the communications network.

### CROSS REFERENCE TO RELATED APPLICATIONS

This application is a continuation application of international patent application PCT/EP2023/081803, filed on Nov. 14, 2023, and designating the U.S., which claims priority to Luxembourg patent application LU503109, filed on Nov. 24, 2022, each of which are hereby incorporated by reference in their entireties.

### TECHNICAL FIELD

The present disclosure relates to a master for connecting to a communications network, a coupler for connecting a master to a slave, a slave for connecting to a master of a communications network, and a communications network having the master and the slave and/or the coupler. A method for operating the master is further provided.

### BACKGROUND

The subsequent discussion of the prior art is not to be construed as an admission that this prior art is generally known or is part of general technical knowledge in the technical field underlying the disclosure.

In automation technology, a communications system known under the brand name IO-Link is used to connect intelligent sensors and actuators to an automation system, which is standardized in the IEC 61131-9 standard under the name single-drop digital communication interface for small sensors and actuators (SDCI). The standardization comprises both the electrical connection data and a digital communications protocol by means of which the sensors and actuators exchange data with the controller.

The “IO-Link Interface and System Specification Version 1.1.3” (dated June 2019, available at: https://io-link.com/share/Downloads/Package-2020/IOL-Interface-Spec_10002_V113_Jun19.pdf) provides information relating to the basic mode of operation of the IO-Link standard.

An IO-Link system comprises an IO-Link master and one or more IO-Link devices, i.e. sensors or actuators. The IO-Link master acts as a gateway, i.e. it provides the interface to the higher-level controller (PLC) or to the host (processor) and controls the communication between the host and the connected IO-Link devices.

An IO-Link device can be an intelligent sensor, actuator, hub or, due to bidirectional communication, also a mechatronics component, e.g. a gripper or a power supply unit having an IO-Link connection. With regard to IO-Link, the term “intelligent” means that a device has identification data, e.g. a type designation and a serial number or parameter data (e.g. sensitivities, switching delays and/or characteristics) that are readable or writeable via the IO-Link protocol. This means that the PLC can change parameters in some cases during ongoing operation. However, the term “intelligent” also means that the device can provide detailed diagnostic information.

In order to exchange data between an IO-Link device and a PLC or host, the IO-Link data are mapped from the IO-Link master onto the fieldbus that is used. This is referred to as IO-Link mapping onto the fieldbus. If the IO-Link master is directly connected to a PLC via a proprietary backplane bus, the IO-Link data are mapped onto this bus and are transmitted to the PLC or from the PLC to the IO-Link master and on to the IO-Link device. Specifications for IO-Link mapping for PROFIBUS, PROFINET, INTERBUS, AS-i, EtherCAT and Powerlink already exist.

During cyclic data exchange, process data are transmitted from and/or to the IO-Link device via the fieldbus or backplane bus. The parameter data must be explicitly requested by the PLC or must be transmitted flagged as such. The ISDU (indexed service data unit) is defined in the IO-Link specification for this purpose. Parameter values and states can be queried in an IO-Link device using indices and subindices. The requests (read-write services) are encoded in the IO-Link master into an IO-Link-specific ISDU and are transmitted to the IO-Link device via the IO-Link interface. The ISDU specifies whether the request is a read or write request. The indices specify the parameters of which the values are to be read or written.

The IO-Link standard is based on a point-to-point bus topology, so that there is conventionally no way to access a coupler which is connected between an IO-Link master and an IO-Link device and which loops through information or data packets between these two IO-Link components. In other words, the coupler is initially transparent and cannot be activated by conventional means.

In addition, the conventional IO-Link standard can be used to parameterize an IO-Link device, but rights to write to and/or read from certain indexes cannot be managed or cannot be adequately managed.

### SUMMARY

Provided is a master for connecting to a communications network, wherein the master is designed to output process data cyclically and device data acyclically to the communications network in accordance with a predetermined communications standard, wherein the master is designed to output a predetermined control command comprising a predetermined password to the communications network as part of the device data.

Provided is a slave for connecting to a master of a communications network, wherein the slave is designed to receive device data from the master in accordance with a predetermined communications standard and to output these data to the master in accordance with the predetermined communications standard. The slave is designed to receive a predetermined control command comprising a predetermined password from the master as part of the device data, and in response to the received predetermined control command comprising the predetermined password, to switch from a slave transmit mode, in which the slave is designed to exchange data with the master in accordance with the predetermined communications standard, to a protected slave operating mode, in which the slave is parameterizable to a degree extending beyond a slave configuration mode.

Provided is a coupler for connecting a master to a slave of a communications network, wherein the coupler is designed to receive device data from the master in accordance with a predetermined communications standard and to output these data to the slave in accordance with the predetermined communications standard. The coupler is designed to initially receive a further predetermined control command from the master via the communications network as part of the device data, in response to the received further predetermined control command, to switch from a coupler transmit mode, in which the coupler is designed to output data received from the master in accordance with the predetermined communications standard to the slave in accordance with the predetermined communications standard, to a coupler configuration mode, in which the coupler is parameterizable by the master, to receive a predetermined control command comprising a predetermined password from the master via the communications network as part of the device data, and in response to the received predetermined control command comprising the predetermined password, to switch from the coupler configuration mode to a protected coupler operating mode, in which the coupler is parameterizable to a degree extending beyond the coupler configuration mode.

### BRIEF DESCRIPTION OF THE DRAWINGS

In the drawings:

FIG. 1 shows schematically a communications network as disclosed, and

FIG. 2 shows schematically a flow diagram of a method for controlling the communications network.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A master for connecting to a communications network may be provided, wherein the master is designed to output process data cyclically and device data acyclically to the communications network in accordance with a predetermined communications standard, wherein the master is designed to output a predetermined control command comprising a predetermined password to the communications network as part or by means of the device data.

All devices described herein may comprise one or more communication interfaces for receiving and/or outputting data from/to the communications network. The communication interfaces may be digital and/or analog communication interfaces.

The master can be a control device which is designed to process data received from the slave via the coupler and/or to output data via the coupler to the slave to control an operation of the slave, and to output data to the coupler to control an operation of the coupler. These data can be the device data, which can be distinguished from the process data described later. The device data can be used to parameterize the coupler and the slave. Additionally or alternatively, the master can be a gateway which is designed to receive data from a control and management system in a further communications standard (e.g. Ethernet) and to output these data to the coupler and the slave in the predetermined communications standard (e.g. IO-Link), and optionally, vice versa, to receive data from the coupler and the slave in the predetermined communications standard and output these data to the control and management system in the further communications standard.

The device data can be communicated acyclically in accordance with the predetermined communications standard, triggered by the master. The predefined communications standard can be IO-Link.

More precisely, three different types of data are exchanged or transmitted in accordance with the IO-Link protocol of the IO-Link (communications) standard, i.e. process data, device parameters and events (comprising the three categories of errors, warnings and notifications).

Process data are transmitted cyclically. Device parameters or general device data and events are transmitted acyclically. The IO-Link device or slave transmits data only if it is requested to do so by the IO-Link master. Process data are transmitted cyclically with each frame. Device parameter data are explicitly requested by the master, i.e. a transmission of device data is triggered by the master.

The master described above may offer a number of advantages. One of these advantages may be the facility to provide special functions (such as a switchover of operating modes, which are to be defined or are defined, of at least one IO-Link device, here the coupler) by means of IO-Link communication, which cannot be mapped by the IO-Link standard. In addition, the master offers the advantage that it can switch devices of the communications network to a (password) protected (operating) mode by means of the password contained in the control command. It is conceivable that the predetermined control command comprising the predetermined password is not stored in a public IODD (see above for details of the IODD), so that the control command, which can be stored in the device data e.g. as a string, can be used as a password to switch to the protected (operating) mode of the devices of the communications network.

The communications network can have a coupler. The master can be designed to first output a further predetermined control command to the coupler by means of the device data in such a way that the coupler switches from a coupler transmit mode, in which the coupler is designed to output data received from the master in accordance with the predetermined communications standard to the slave in accordance with the predetermined communications standard, to a coupler configuration mode in which the coupler is parameterizable by the master. The master can be designed to output the predetermined control command comprising the predetermined password to the coupler by means of the device data in such a way that the coupler switches from the coupler configuration mode to a protected coupler operating mode, in which the coupler is parameterizable to a degree extending beyond the coupler configuration mode.

In other words, it is conceivable, for example, that the current operating mode (i.e. the operating mode to which the coupler is set at the time of receiving the further predetermined control command) is transmit mode, and the coupler switches to configuration mode due to the further predetermined control command.

In transmit mode, the data can be transmitted (optionally bi-directionally) via the coupler from the master to the slave. In configuration mode, the data transmission between the master and the slave can be stopped until the parameterization of the coupler has been completed. It is then conceivable that the coupler automatically switches back to transmit mode, or that the predetermined control command comprising the password is in turn output to the coupler so that the coupler switches to the protected coupler operating mode.

Device settings and/or characteristics of the coupler, for example, which are modifiable only or exclusively in the protected operating mode can then be read out and/or modified in the protected operating mode. It is then conceivable that the coupler automatically switches back to transmit mode or that a (further) predetermined control command is output to the coupler so that the coupler switches (back) to transmit mode.

In other words, a two-stage procedure can be implemented, in which the current operating mode of the coupler is the coupler transmit mode, and the coupler switches to the coupler configuration mode due to a function called by a first control command. As soon as the coupler is set to the coupler configuration mode, it is conceivable that the coupler switches to the protected coupler operating mode due to a function called by a second control command comprising the password. This can be referred to as a two-stage method, wherein the second control command acts as a password to switch from the coupler configuration mode to the protected coupler operating mode.

Thus, it may be unnecessary to adjust or operate the coupler additionally in order to control the coupler. Instead, the coupler can be controlled directly by means of the transmitted control commands using the underlying communications standard, and therefore in the field.

A coupler can be understood to mean an electronic component for galvanic isolation and optionally for the isolation protection of signals. The signals can be separated optically by means of optocouplers, but also, additionally or alternatively, by means of a transformer coupler or capacitive coupler, or magnetically using a magnetic coupler. The signals can be used to transmit the data. In other words, the coupler can be used for bi-directional loop-through of data or signals.

The communications network can have a slave. The master can be designed to use the device data to output the predetermined control command comprising the predetermined password to the slave in such a way that the slave switches from a slave transmit mode, in which the slave is designed to exchange data with the master in accordance with the predetermined communications standard, (optionally directly) to a protected slave operating mode, in which the slave is parameterizable to a degree extending beyond a slave configuration mode.

Thus, it may be unnecessary to adjust or operate the slave additionally in order to control the slave. Instead, the coupler can be controlled directly by means of the transmitted control commands using the underlying communications standard, and therefore in the field.

The slave can be a field device, e.g. an actuator and/or a sensor. A field device (FD) can be understood to mean a technical facility in the automation technology domain which is directly related to a production process. In automation technology, the term “field” refers to the area outside control cabinets or control rooms. Field devices can therefore be both actuators (manual controllers, valves, etc.) and sensors (measuring transducers) in factory and process automation. The field device can be connected to a control and management system, usually via a fieldbus, or increasingly also via real-time Ethernet. The data received from the field device are evaluated in the control and management system and can be used to regulate and/or control the production process and, additionally or alternatively, for further processing. A state of the production process (e.g. valve opened/closed, pressure, flow rate, temperature, etc.) can be for example visualized and displayed as part of the further processing.

The slave and/or the coupler can be configured as IO-Link devices. The slave can therefore be a sensor, actuator, hub, and/or a mechatronics component, e.g. a gripper and/or a power supply unit with an IO-Link connection. The master can be configured as an IO-Link master. As described above, IO-Link is a standardized IO technology (IEC 61131-9) for communicating with IO-Link devices, such as sensors and actuators. IO-Link is based on point-to-point communication using a 3-wire IO-Link device connection without any additional requirements for the cable material. IO-Link is therefore not a fieldbus and is thus fieldbus-independent. The explanations above can be referred to for further details on IO-Link.

A coupler is further provided for connecting a master, optionally the master described above, to a slave, optionally the slave described above, of a communications network, wherein the coupler is designed to receive device data from the master in accordance with a predetermined communications standard and output these data to the slave in accordance with the predetermined communications standard.

The coupler is designed initially to receive a further predetermined control command from the master via the communications network by means of the device data. The coupler is designed to switch, in response to the received further predetermined control command, from a coupler transmit mode, in which the coupler is designed to output data received from the master in accordance with the predetermined communications standard to the slave in accordance with the predetermined communications standard, to a coupler configuration mode, in which the coupler is parameterizable by the master.

The coupler is designed to receive a predetermined control command comprising a predetermined password from the master via the communications network by means of the device data. The coupler is designed to switch, in response to the received predetermined control command comprising the predetermined password, from the coupler configuration mode to a protected coupler operating mode, in which the coupler is parameterizable to a degree extending beyond the coupler configuration mode.

The device data can be communicated acyclically according to the predetermined communications standard, triggered by the master.

The coupler can be designed to output information to the master via the communications network in response to the detected predetermined control command and/or in response to the detected further predetermined control command.

The coupler can be designed to receive process data from the master in accordance with the predetermined communications standard and to output these data to the slave via the communications network in accordance with the predetermined communications standard. The process data can be communicated cyclically in accordance with the predefined communications standard.

The coupler can be designed to receive further process data and/or further device data from the slave in accordance with a predetermined communications standard and to output these data to the master in accordance with the predetermined communications standard. The further process data can be communicated cyclically in accordance with the predefined communications standard. The further device data can be communicated in accordance with the predetermined communications standard, triggered by the master, optionally by means of an additional service data unit and/or acyclically.

The coupler can have an inductive coupler or can be configured as such. An inductive coupler can be understood to mean a transformer in which the transformer core is divisible, i.e. both parts can be separated from each other. The primary winding is positioned on one part of the core and the secondary winding is positioned on the other part of the core. In addition to the transmission of data, the inductive coupler allows the transmission of electrical energy from the master to the slave.

The description above relating to the master also applies accordingly to the coupler, and vice versa.

A slave is further provided for connection to a master, optionally to the master described above, of a communications network, wherein the slave is designed to receive device data from the master in accordance with a predetermined communications standard and to output these data to the master in accordance with the predetermined communications standard. The slave is designed to receive a predetermined control command comprising a predetermined password from the master by means of the device data. The slave is designed to switch, in response to the received predetermined control command comprising the predetermined password, from a slave transmit mode, in which the slave is designed to exchange data with the master in accordance with the predetermined communications standard, to a protected slave operating mode, in which the slave is parameterizable to a degree extending beyond a slave configuration mode.

The slave can be designed to be connected to the master via a coupler, optionally the coupler described above.

The description above relating to the master and to the coupler also applies accordingly to the slave, and vice versa.

The device data can comprise a service data unit in accordance with a predetermined communications protocol of the predetermined communications standard, said service data unit having an area in which a plurality of standard parameters are storable in accordance with the predetermined communications protocol, and the predetermined control command and/or the predetermined further control command can be stored in this area.

More precisely, parameter data are explicitly requested by the IO-Link master in accordance with the IO-Link protocol of the IO-Link (communications) standard or are transmitted flagged as such. A service data unit, known as an ISDU (indexed service data unit), is defined in the IO-Link specification for this purpose. Parameter values and states can be queried, and parameters can be stored in the IO-Link device using indices and subindices. The requests (read-write services) are encoded in the IO-Link master into an IO-Link-specific ISDU and are transmitted via the IO-Link interface to the IO-Link device. The ISDU specifies whether the request is a read or write request. The indices specify the parameters of which the values are to be read or written. It is now proposed to use this ISDU optionally to transmit the respective control command from the master to the coupler and/or the slave.

Up to 65536 indices up to 232 bytes in size can be addressed via IO-Link. The IO-Link specification already contains predefined indices (predefined parameters). The IO-Link devices can be uniquely identified by means of these indices. However, most of the defined indices are optional, i.e. they can be used but are not mandatory. The advantage of using the indices that have already been defined and have been implemented as mandatory for transmitting the control command is that they are available in every IO-Link device (as from a specific version).

In the area of the service data unit, in which a plurality of standard parameters are storable in accordance with the predetermined communications protocol, a first sub-area can be provided for an application-specific tag, a second sub-area can be provided for a location tag and/or a third sub-area can be provided for a function tag in accordance with the predetermined communications protocol, and the predetermined control command and/or the predetermined further control command can be stored in at least one of these sub-areas.

This may provide the advantage that these sub-areas are large enough to transmit a control command.

The above description can be summarized in other words and with reference to a more specific implementation as described below, wherein the following description is given only by way of example and is therefore not limiting for the disclosure.

IO-Link standard parameters (mandatory parameters in accordance with the IO-Link specification in the ISDU area) can be used to control exclusive device functions. This means that commands can be sent to the address of a selected default parameter. The commands cannot be used to change the contents of the parameter, but to trigger an action or function. The command sets that are used can be defined in advance for this purpose. It is conceivable that they are not outwardly visible. It is very unlikely that an error will occur at this point, because the commands can be selected such that they do not collide with standard commands or contents. It is also possible that password access can be implemented with the described solution. In addition to triggering an action, there may further be the option of returning responses (answers to the command). Reading can be performed in the subsequent ISDU frame or within a given period of time, optionally less than 10s after receiving the command. This function can be particularly useful in development and testing, as it allows an extended fault diagnosis by the manufacturer. Specifically, a type of command line interface can be implemented here which allows a command to be sent in the manner described above and the answer/response to the sent command to be read out. The use of ISDU area parameters which have a corresponding size and are available in all devices as from a specific version can be advantageous. The use of the parameters of the application-specific tag, the location tag or the function tag can be particularly suitable for this purpose. The commands can be used to switch the operating modes of infrastructure components. Infrastructure components of this type, such as inductive couplers, offer not only the transmission of supply power from connected devices, but also IO-Link communication (loop-through between master-coupler-device) with the connected device. In addition to this transmit mode, there can be another operating mode for configuring the coupler itself, known as the configuration mode, since this cannot be possible in transmit mode due to the active communication. The solution proposed here allows these two modes to be switched by sending a command, for example, to the address of the application-specific tag. The coupler can then be configured and optionally reset to transmit mode. As a further stage, if the coupler is in configuration mode, it can be provided to switch to a protected operating mode or administrator mode. For this purpose, a further command can be sent to the coupler in the manner described above, wherein the command comprises a password which, for example, is sent in turn as a string to the address of the application-specific tag (or another of the above-mentioned tags). The password can comprise a switchover of the coupler from configuration mode to administrator mode, wherein parameters or settings of the coupler can be modifiable and/or readable in administrator mode, but cannot be accessed in configuration mode.

A communications network is further provided, wherein the communications network comprises a master described above and a coupler described above connected to the master and/or a slave described above connected to the master.

The communications network can have a control and management system which is connected to the slave via the master and the coupler. It is conceivable that the control and management system communicates with the master in accordance with a further predetermined communications standard (e.g. PROFIBUS, PROFINET, INTERBUS, AS-i, EtherCAT, Ethernet, or Powerlink).

The description above relating to the master, coupler and slave also applies accordingly to the communications network, and vice versa.

A method is further provided for operating a master, optionally the master described above, for connecting to a communications network. The method comprises cyclically outputting process data and acyclically outputting device data to the communications network in accordance with a predetermined communications standard. The method comprises outputting a predetermined control command comprising a predetermined password to the communications network by means of the device data.

The method can be a computer-implemented method, i.e. one, a plurality or all steps of the method can be carried out at least partially by a computer or a data processing device.

The description above relating to the master, the coupler, the slave and the communications network also applies accordingly to the method, and vice versa.

A computer program and/or computer-readable medium is/are further provided, comprising commands which, when the program or commands is/are executed by a master, optionally the master described above, for connecting to a communications network, cause the master to carry out, at least partially, the method described above.

The computer program can be firmware of the master. Firmware can be understood to mean software which is (permanently) embedded in electronic devices, such as the master here, and performs basic functions there. The firmware can take up an intermediate position between the hardware of the master (i.e. the physical components of the master) and any existing application software (known as the function). The firmware can be stored in a memory of the master. The memory can be a flash memory, EPROM, EEPROM, or ROM.

The computer-readable medium can have the computer program described above.

The computer-readable medium can be a computer-readable storage medium, i.e. any digital data storage device, such as a USB stick, a hard disk, a flash memory, a CD-ROM, an SD card or an SSD card.

The computer program or commands do not necessarily have to be stored on such a computer-readable storage medium in order to be made available to the master, but can also be obtained via the Internet or from some other external source.

The description above relating to the master, the coupler, the slave, the communications network and the method also applies accordingly to the computer program and/or the computer-readable medium, and vice versa.

It should also be noted that, unless otherwise defined, all technical and scientific terms used herein have the same meaning as generally understood by a person skilled in the art to which this disclosure relates. If a plurality of definitions exist for a term, the definitions in this description will take precedence, unless otherwise indicated.

Wherever the expressions “for example”, “such as”, “including” and the like are used, they shall be construed as if they were followed by the term “and without limitation”, unless expressly indicated otherwise. Similarly, the terms “an example”, “by way of example”, and the like are to be understood as non-limiting or as a non-exhaustive listing.

Indications of numbers are to be understood as both final and non-final, i.e., for example, “a/one slave” is to be understood as “at least one slave and/or exactly one slave”.

The term “substantially” allows for deviations that do not adversely affect the intended purpose. Descriptive terms are to be understood as being modified by the term “substantially”, even if the term “substantially” is not explicitly mentioned.

The terms “comprising” and “including” and “having” and “incorporating” (and similarly “comprises”, “includes”, “has”/“with” and “incorporates”) and the like are used synonymously and have equal significance.

Consequently, unless the context clearly or explicitly requires otherwise, the words “comprise”, “comprising” and the like in the description and in the claims are to be understood in an inclusive sense and not in an exclusive or exhaustive sense, i.e., in the sense of “including but not limited to”.

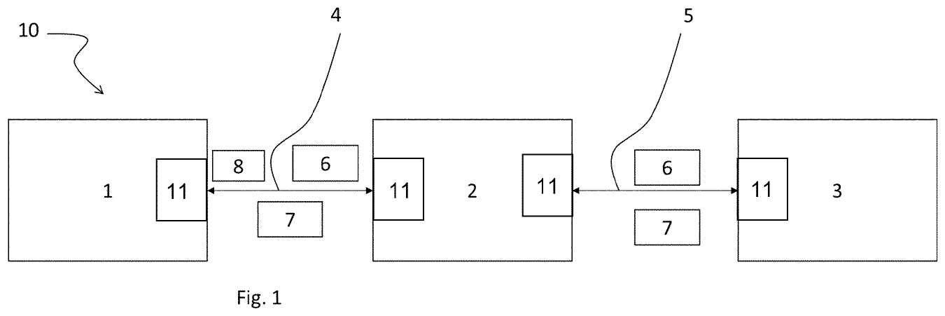

The communications network 10 shown in FIG. 1 has a master 1, a coupler 2 and a slave 3 connected via the coupler 2 and two data lines 4, 5 to the master 1. Bi-directional (data) communication takes place in accordance with the IO-Link standard between the master 1 and the slave 3 via the coupler 2 and the two data lines 4, 5. The coupler 2 is therefore designed to receive data from the master 1 in accordance with the IO-Link standard and to forward the data to the slave 3 in accordance with the IO-Link standard, and to receive data from the slave 3 in accordance with the IO-Link standard and to forward the data to the master 1 in accordance with the IO-Link standard. The master 1, the coupler 2 and the slave 3 each comprise a digital communication interface 11 for receiving and/or outputting said data from/to the communications network 10. Any data exchange or (data) communication mentioned below is compliant with the IO-Link standard. A higher-level control and management system (not shown) can be connected to the master 1, said system serving to control and monitor a process in which the slave 3 configured as a field device is used.

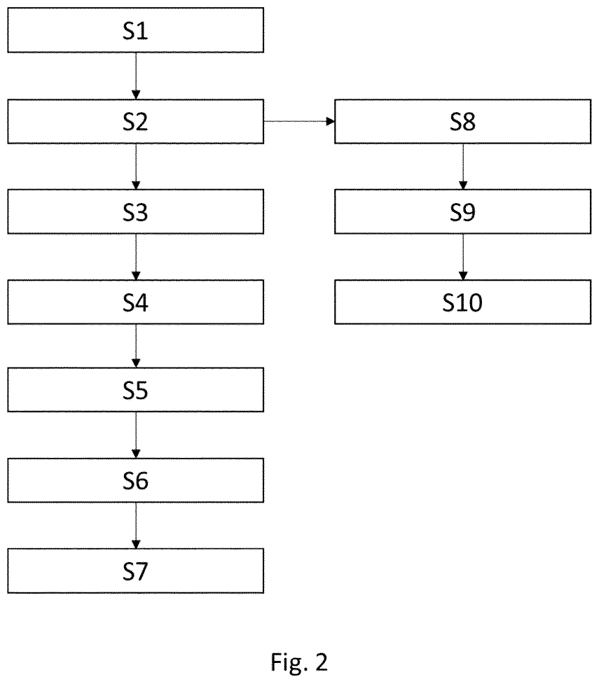

The communications network 10 is operated according to the method as disclosed for operating the communications network 10, the flow diagram of which is shown schematically in FIG. 2 and which is explained in detail below.

In a first step S1 of the method, process data 6 are exchanged cyclically via the coupler 2 and the data lines 4, 5 between the master 1 and the slave 3. During the first step S1, device data 7 in the form of service data units are exchanged repeatedly and acyclically in accordance with the IO-Link protocol, triggered by the master 1, via the coupler 2 and the data lines 4, 5 between the master 1 and the slave 3 in order to parameterize the slave 3.

From the perspective of the master 1, the process data 6 can comprise input data, the values measured by the slave 3 (such as temperature, distance, volume, rotational speed, flow rate, etc.), and/or output data, comprising control data (e.g. rotational speed, pressure or pressure difference, lamp on/off, light color, blinking pattern, output voltage, output current) for the slave 3 (e.g. to control actuators, such as e.g. motors, valves, signal lights, power supply units, by means of the slave 3).

The coupler 2 is initially set to a coupler transmit mode, in which the coupler 2, in addition to the process data, also forwards these device data 7 intended for the slave 3 or for the master 1, essentially without modification, i.e. the coupler 2 loops through these device data 7 as well as the process data 6. However, the coupler 2 does not loop through the service data unit of the device data 7 if these data contain a first predetermined control command.

In order to determine this, in a second step S2 of the method running parallel or simultaneously with the first step S1, the coupler 2 checks the service data units of the device data 7 received from the master 1 to determine whether they contain the first predetermined control command.

More precisely, the service data units of the device data 7 comprise an area in which a plurality of standard parameters are storable in accordance with the IO-Link protocol, wherein the master 1 stores the predetermined control command in this area. It is conceivable that the master 1 stores the predetermined control command as a string in the sub-area provided for the application-specific tag, the location tag and/or the function tag. The coupler 2 therefore checks these sub-areas to see whether the first predetermined control command is contained in one of them.

If the first predetermined control command is detected by the coupler 2 in the second step S2, the coupler 2 outputs information 8 to the master 1 via the data line 4 in response to the detected first control command, and the method continues with a third step S3. Otherwise, the first and second steps S1, S2 will continue to be carried out. The information can be an acknowledgment of receipt of the first predetermined control command and a termination of the connection or a suspension of the loop-through of process data 6 so that the connection to the master 1 can then be re-established in configuration mode (see steps S3 and S4).

In the third step S3 of the method, the coupler 2 calls a function stored in the coupler 2 depending on the first predetermined control command detected in the device data 7. A plurality of functions can be stored in the coupler 2, wherein the first predetermined control command is then designed such that the coupler 2 can uniquely assign the first predetermined control command to at least one of these functions.

In a fourth step S4 of the method, the coupler 2 performs the function called in the third step S3. The function can be a function that switches the coupler 2 from the current operating mode to a further or different operating mode defined in the function. This can, for example, be a coupler configuration mode in which the coupler 2 can be parameterized by means of the master 1.

In a fifth step S5 of the method, as soon as the coupler 2 is set to configuration mode, the coupler 2, in a manner similar to the second step 2 of the method, checks the service data units of the device data 7 received from the master 1 after switching to coupler configuration mode to determine whether they contain a second predetermined control command comprising a predetermined password.

More precisely, these service data units of the device data 7 received following the switchover to coupler configuration mode on the coupler 2, similar to the service data described above, comprise the area in which a plurality of standard parameters are storable in accordance with the IO-Link protocol, wherein the master 1 stores the second predetermined control command comprising the predetermined password in this area. It is conceivable that the master 1 stores the second predetermined control command comprising the predetermined password as a string in the sub-area provided for the application-specific tag, the location tag and/or the function tag. The coupler 2 therefore checks these sub-areas to see whether the second predetermined control command comprising the predetermined password is contained in one of them.

If the control command is detected by the coupler 2 in the fifth step S5, the coupler 2 can output further information 8 to the master 1 via the data line 4 in response to the detected second control command comprising the password, and the method continues with a sixth step S6.

In the sixth step S6 of the method, similar to the third step S3 of the method, the coupler 2 calls a function stored in the coupler 2 depending on the second predetermined control command comprising the predetermined password detected in the device data 7. A plurality of functions can be stored in the coupler 2, wherein the second predetermined control command comprising the predetermined password is then designed such that the coupler 2 can uniquely assign the first predetermined control command to at least one of these functions.

In a seventh step S7 of the method, the coupler 2 performs the function called in the sixth step S6. The function can be a function that switches the coupler 2 from the current operating mode to a further or different operating mode defined in the function. This can, for example, be a protected coupler operating mode or coupler admin mode in which the coupler 2 can be parameterized by means of the master 1. The coupler admin mode differs from the coupler configuration mode described above in that, in the coupler admin mode, the coupler 2 is parameterizable to a degree that extends beyond the coupler configuration mode.

In other words, the coupler admin mode can be activated in the coupler 2, optionally within the coupler configuration mode, or can be enabled by means of the predetermined password contained in the second predetermined control command in order to gain access to further IO-Link indices that are not available in configuration mode. This means that, in the coupler admin mode, the coupler can be parameterized to a degree that extends beyond the coupler configuration mode. This can be used for extended fault diagnostics or for manufacturer parameterization. In order to switch from coupler configuration mode to coupler admin mode, the second, third and fourth steps S2, S3, S4 of the method can be carried out repeatedly as the fifth, sixth and seventh steps S5, S6, S7 as soon as the coupler 2 is set to coupler configuration mode.

However, the method described above also allows the possibility that the device data 7 contains a predetermined control command comprising a predetermined password for the slave 3, with which the slave 3 can be switched from a slave transmit mode to a protected slave operating mode or slave admin mode.

To do this, the method comprises an eighth step S8 following the first and the second steps S1, S2 of the method. In the eighth step S8 of the method, the slave 3 (which is initially set to slave transmit mode, in which the slave 3 exchanges process data 6 and device data 7 with the master 1 via the coupler 2 in accordance with the IO-Link standard), similar to the second step S2 of the method, checks the service data units of the device data 7 received from the master 1 to determine whether they contain a predetermined control command comprising a predetermined password. See above for further details relating to the service data.

If the first predetermined control command is detected by the slave 3 in the eighth step S8, the slave 3 can optionally output the information 8 via the data line 4 to the master 1 in response to the detected predetermined control command, and the method continues with a ninth step S9.

Otherwise, the first, second, and eighth steps S1, S2, S8 will continue to be carried out. The information can be an acknowledgement of receipt of the predetermined control command.

In the ninth step S9 of the method, the slave 3 calls a function stored in the slave 3 depending on the predetermined control command comprising the predetermined password detected in the device data 7. A plurality of functions can be stored in the coupler 2, wherein the predetermined control command comprising the predetermined password is then designed such that the coupler 2 can uniquely assign the predetermined control command comprising the predetermined password to at least one of these functions.

In a tenth step S10 of the method, the slave 3 performs the function called in the ninth step S9. The function can be a function that switches the slave 3 from the current operating mode to a further or different operating mode defined in the function. This can, for example, be a protected slave operating mode or slave admin mode, in which the slave 3 is parameterizable by the master 1. The slave 3 can therefore be switched directly from slave transmit mode to slave admin mode. The slave admin mode differs from a slave configuration mode in that, in the slave administration mode, the slave 3 is parameterizable to a degree that extends beyond the slave configuration mode. Further details relating to the slave configuration mode and the slave admin mode can be found by referring to the coupler configuration mode and the coupler admin mode.

### LIST OF REFERENCE CHARACTERS

1 Master
2 Coupler
3 Slave
4 Data line between master and coupler
5 Data line between slave and coupler
6 Process data
7 Device data
8 Information in response to control command
10 Communications network
11 (optionally digital) communication interface
S1-S10 Method steps

What is claimed is:

1. A master for connecting to a communications network comprising a communication interface, wherein the master is designed to output process data cyclically and device data acyclically to the communications network via the communication interface in accordance with a predetermined communications standard, wherein the master is designed to output a predetermined control command comprising a predetermined password to the communications network as part of the device data.

2. The master as claimed in claim 1, wherein the communications network includes a coupler, wherein the master is designed:
to initially output a further predetermined control command to the coupler as part of the device data such that the coupler switches from a coupler transmit mode, in which the coupler is designed to output data received from the master in accordance with the predetermined communications standard to a slave in accordance with the predetermined communications standard, to a coupler configuration mode, in which the coupler is parameterizable by the master, and
to output the predetermined control command comprising the predetermined password as part of the device data to the coupler so that the coupler switches from the coupler configuration mode to a protected coupler operating mode, in which the coupler is parameterizable to a degree extending beyond the coupler configuration mode.

3. The master as claimed in claim 1, wherein the communications network includes a slave, wherein the master is designed to output the predetermined control command comprising the predetermined password to the slave as part of the device data such that the slave switches from a slave transmit mode, in which the slave is designed to exchange data with the master in accordance with the predetermined communications standard, to a protected slave operating mode, in which the slave is parameterizable to a degree extending beyond a slave configuration mode.

4. A coupler for connecting a master to a slave of a communications network, the coupler comprising a first communication interface and a second communication interface;
wherein the coupler is designed to receive device data from the master via the first communication interface in accordance with a predetermined communications standard and to output these data to the slave via the second communication interface in accordance with the predetermined communications standard,
wherein the coupler is designed:
to initially receive a further predetermined control command from the master via the communications network as part of the device data,
in response to the received further predetermined control command, to switch from a coupler transmit mode, in which the coupler is designed to output data received from the master in accordance with the predetermined communications standard to the slave in accordance with the predetermined communications standard, to a coupler configuration mode, in which the coupler is parameterizable by the master,
to receive a predetermined control command comprising a predetermined password from the master via the communications network as part of the device data, and
in response to the received predetermined control command comprising the predetermined password, to switch from the coupler configuration mode to a protected coupler operating mode, in which the coupler is parameterizable to a degree extending beyond the coupler configuration mode.

5. The coupler as claimed in claim 4, wherein the device data are communicated acyclically in accordance with the predetermined communications standard, triggered by the master.

6. The coupler as claimed in claim 4, wherein the coupler is designed to output information to the master via the communications network in response to the received predetermined control command and/or in response to the received further predetermined control command.

7. The coupler as claimed in claim 4, wherein:
the coupler is designed to receive process data from the master in accordance with the predetermined communications standard and to output these data to the slave in accordance with the predetermined communications standard via the communications network.

8. The coupler as claimed in claim 7, wherein the process data are communicated cyclically in accordance with the predetermined communications standard.

9. The coupler as claimed in claim 4, wherein the coupler is designed to receive further process data and/or further device data from the slave in accordance with a predetermined communications standard and to output these data to the master in accordance with the predetermined communications standard.

10. The coupler as claimed in claim 9, wherein the further process data are communicated cyclically in accordance with the predetermined communications standard.

11. The coupler as claimed in claim 9, wherein the further device data are communicated in accordance with the predetermined communications standard, triggered by the master.

12. The coupler as claimed in claim 11, wherein the master is designed to trigger the further device data using a further service data unit and/or to trigger the further device data acyclically.

13. The coupler as claimed in claim 4, wherein the coupler has an inductive coupler or is designed as such.

14. A slave for connecting to a master of a communications network, the slave comprising a communication interface;
wherein the slave is designed to receive device data from the master via the communication interface in accordance with a predetermined communications standard and to output these data to the master in accordance with the predetermined communications standard,
wherein the slave is designed:
to receive a predetermined control command comprising a predetermined password from the master as part of the device data, and
in response to the received predetermined control command comprising the predetermined password, to switch from a slave transmit mode, in which the slave is designed to exchange data with the master in accordance with the predetermined communications standard, to a protected slave operating mode, in which the slave is parameterizable to a degree extending beyond a slave configuration mode.

15. The slave as claimed in claim 14, wherein the slave is designed to be connected to the master via a coupler.

16. The master as claimed in claim 2, wherein:
the device data comprise a service data unit in accordance with a predetermined communications protocol of the predetermined communications standard, said service data unit having an area in which a plurality of standard parameters are storable in accordance with the predetermined communications protocol, and
the predetermined control command and/or the further predetermined control command is/are stored in this area.

17. The master as claimed in claim 16, wherein:
in the area of the service data unit, in which a plurality of standard parameters are storable in accordance with the predetermined communications protocol, a first sub-area is provided for an application-specific tag, a second sub-area is provided for a location tag and/or a third sub-area is provided for a function tag in accordance with the predetermined communications protocol, and
the predetermined control command and/or the predetermined further control command is/are stored in at least one of these sub-areas.

18. A communications network, wherein the communications network comprises a master as claimed in claim 1, and a coupler connected to the master and/or a slave connected to the master.

19. A method for operating a master as claimed in claim 1 for connecting to a communications network, wherein the method comprises:
cyclically outputting process data and acyclically outputting device data to the communications network in accordance with a predetermined communications standard, and
outputting a predetermined control command comprising a predetermined password to the communications network as part of the device data.
